(19) United States
(12) Patent Application Publication
(10) Pub. No.: US 2018/0203267 A1
(43) Pub. Date: Jul. 19, 2018

(54) SEALANT, LIQUID CRYSTAL DISPLAY PANEL AND LIQUID CRYSTAL DISPLAY DEVICE

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Chuanyan WANG, Beijing (CN); Dandan ZHANG, Beijing (CN)

(21) Appl. No.: 15/539,747

(22) PCT Filed: Jan. 3, 2017
(86) PCT No.: PCT/CN2017/000047

§ 371 Date: Jun. 26, 2017

(30) Foreign Application Priority Data
Jun. 15, 2016 (CN) 201610423025.1

(51) Int. Cl. G02F 1/1339; G02F 1/1335

(52) U.S. Cl. CPC G02F 1/1339; G02F 1/133514; G02F 1/133512

(57) ABSTRACT

A sealant, a liquid crystal display panel and a liquid crystal display device that can eliminate defects during electrostatic testing are provided. The phenomenon of greenish edge and light leakage can also be avoided. The liquid crystal display panel includes an array substrate and a counter substrate arranged opposite to the array substrate; a black matrix arranged on a side of the counter substrate facing the array substrate; and a sealant including a matrix material and an insulating material mixed in the matrix material. The sealant is arranged between the array substrate and the counter substrate and arranged at a periphery of the black matrix to form a sealed cavity.

### RELATED APPLICATIONS

The present application is the U.S. national phase entry of the international application PCT/CN2017/000047, with an international filing date of Jan. 3, 2017, which claims the benefit of Chinese Patent Application No. 201610423025.1, filed on Jun. 15, 2016, the entire disclosures of which are incorporated herein by reference.

### TECHNICAL FIELD

The present invention relates to the field of display technology, in particular to a sealant, a liquid crystal display panel and a liquid crystal display device.

### BACKGROUND

At present, the electrostatic testing requirement for liquid crystal display (LCD) panel is ever increasing. In order to reduce the cost, the backlight of the LCD device is usually a nonmetallic backlight module. However, due to the weak conductivity of nonmetallic backlight modules, there may be problems in electrostatic testing. Moreover, in the liquid crystal display panel, the contact between the black matrix and the silver paste can also cause problems such as a greenish edge.

### SUMMARY

The inventors have found that if a groove is formed in the black matrix to solve the above defects, the position of the groove can lead to light leakage on the edge. If a paste is applied, cutting on the side opposite to the data pad and the side of the data pad cannot be realized. In the corner, it is difficult to cover the black matrix, thus the defects cannot be eliminated completely.

To this end, the embodiments of the invention provide a sealant, a liquid crystal display panel and a liquid crystal display device, which can eliminate defects during electrostatic testing. The phenomenon of greenish edge and light leakage can also be avoided.

According to an aspect of the invention, an embodiment of the invention provides a sealant. The sealant includes a matrix material and an insulating material mixed in the matrix material.

By applying the insulating material mixed in the matrix material, the sealant can effectively avoid the electrical connection between the silver paste and the peripheral wiring of the liquid crystal display panel when the sealant is used for sealing the liquid crystal display panel, eliminating the defect of burning the wiring during the electrostatic testing process. Due to the existence of the sealant, it is possible to prevent the silver paste from penetrating into the gap between the array substrate and the counter substrate and contacting the black matrix, thereby avoiding the defect of the greenish edge in the liquid crystal display device.

In certain exemplary embodiments, the insulating material is a black insulating pigment.

With the black pigment, the sealant at the edge of the liquid crystal display panel absorbs all the light emitted to the lateral side of the panel, effectively avoiding the light leakage at the edge of the liquid crystal display panel.

In certain exemplary embodiments, the matrix material is a UV curing material or heat curing material.

By applying the UV curing material or heat curing material, the sealant can be cured simply by means of ultraviolet light or heating.

According to another aspect of the invention, an embodiment of the invention provides a liquid crystal display panel. The liquid crystal display panel includes: an array substrate and a counter substrate arranged opposite to the array substrate; a black matrix arranged on a side of the counter substrate facing the array substrate; and a sealant including a matrix material and an insulating material mixed in the matrix material. The sealant is arranged between the array substrate and the counter substrate and arranged at a periphery of the black matrix to form a sealed cavity.

By applying the insulating material mixed in the matrix material, the sealant can effectively avoid the electrical connection between the silver paste and the peripheral wiring of the liquid crystal display panel, eliminating the defect of burning the wiring during the electrostatic testing process. Due to the existence of the sealant, it is possible to prevent the silver paste from penetrating into the gap between the array substrate and the counter substrate and contacting the black matrix, thereby avoiding the defect of the greenish edge in the liquid crystal display device.

In certain exemplary embodiments, the liquid crystal display panel further includes frame sealing glue arranged at an interior of the sealant.

In some embodiments, frame sealing glue is arranged at an interior of the sealant to enhance the bonding between the array substrate and the counter substrate, thereby forming a more stable liquid crystal display panel.

In certain exemplary embodiments, the liquid crystal display panel further includes a silver paste arranged at a periphery of the sealant and electrically connected with the counter substrate.

If the silver paste contacts the black matrix, some charges can be gathered in the black matrix due to the weak conductivity of the black matrix. Then a voltage is on the black matrix, forming a voltage difference with the array substrate, resulting in deflection of liquid crystal and greenish display. By applying the silver paste in this manner, the ability of transmitting static electricity in the liquid crystal display panel can be improved, and the defects of greenish edge in the liquid crystal display device can be further avoided.

In certain exemplary embodiments, the insulating material is a black insulating pigment.

With the black pigment, the sealant at the edge of the liquid crystal display panel absorbs all the light emitted to the lateral side of the panel, effectively avoiding the light leakage at the edge of the liquid crystal display panel.

In certain exemplary embodiments, the matrix material is a UV curing material or heat curing material.

By applying the UV curing material or heat curing material, the sealant can be cured simply by means of ultraviolet light or heating.

In certain exemplary embodiments, the counter substrate is a color film substrate.

The liquid crystal display panel can realize color display by using a color film substrate.

According to yet another aspect of the invention, an embodiment of the invention provides a liquid crystal display device. The liquid crystal display device includes the liquid crystal display panel according to any one of the above mentioned embodiments.

### BRIEF DESCRIPTION OF THE DRAWINGS

FIG. 1 is a structural schematic diagram of a substrate according to an embodiment of the invention;

FIG. 2 is a cross section view of a substrate along the I-I′ line in FIG. 1 according to an embodiment of the invention;

FIG. 3 is a structural schematic diagram of a liquid crystal display panel according to an embodiment of the invention;

FIG. 4 is a structural schematic diagram of a liquid crystal display panel according to another embodiment of the invention;

FIG. 5 is a structural schematic diagram of a liquid crystal display panel according to yet another embodiment of the invention;

FIG. 6 shows a top view of the liquid crystal display panel as shown in FIG. 5; and

FIG. 7 is a flow chart of a method for manufacturing a liquid crystal display panel according to an embodiment of the invention.

### DETAILED DESCRIPTION OF THE INVENTION

In the following, the technical solutions in the embodiments of the invention will be described clearly and completely in connection with the drawings in the embodiments of the invention. Obviously, the described embodiments are only part of the embodiments of the invention, and not all of the embodiments. Based on the embodiments in the invention, all other embodiments obtained by those of ordinary skills in the art under the premise of not paying out creative work pertain to the protection scope of the invention.

According to an aspect of the invention, an embodiment of the invention provides a sealant for a liquid crystal display panel and its manufacturing process. The sealant can be applied on an array substrate or a counter substrate arranged opposite to the array substrate. In the manufacturing process of the liquid crystal display panel, the sealant can be applied to any one of the array substrate and the counter substrate before the array substrate is aligned with the counter substrate.

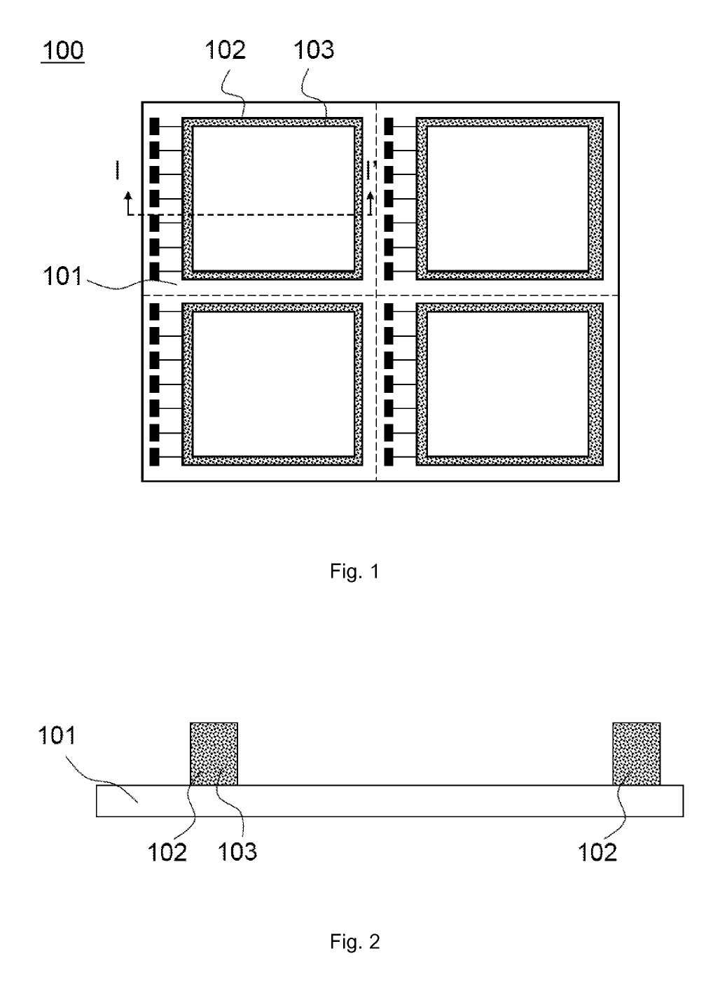

For the sake of convenience in description, an embodiment of the present invention will be described by taking the sealant applied on an array substrate as an example. As shown in FIG. 1 and FIG. 2, the uncut array substrate 100 includes a plurality of individual array substrates 101. A surface of an individual array substrate 101 is coated with a sealant 102 according to an embodiment of the present invention. The sealant 102 includes a matrix material and an insulating material 103 mixed in the matrix material.

By applying the insulating material mixed in the matrix material, the sealant can effectively avoid the electrical connection between the silver paste and the peripheral wiring of the liquid crystal display panel when the sealant is used for sealing the liquid crystal display panel, eliminating the defect of burning the wiring during the electrostatic testing process. Due to the existence of the sealant, it is possible to prevent the silver paste from penetrating into the gap between the array substrate and the counter substrate and contacting the black matrix, thereby avoiding the defect of the greenish edge in the liquid crystal display device.

In certain exemplary embodiments, the insulating material is a black insulating pigment. The insulating material 103 can be selected from a group of the following materials: black inorganic insulating pigment and black organic insulating pigment. For example, the black insulating pigment can be organic matter such as nigrosine.

With the black pigment, the sealant at the edge of the liquid crystal display panel absorbs all the light emitted to the lateral side of the panel, effectively avoiding the light leakage at the edge of the liquid crystal display panel.

In certain exemplary embodiments, the matrix material is a UV curing material or heat curing material. For example, the matrix material can be a UV curing material, such as acrylic resin and carbamate resin. The matrix material can also be a heat curing material, such as epoxy resin.

By applying the UV curing material or heat curing material, the sealant can be cured simply by means of ultraviolet light or heating.

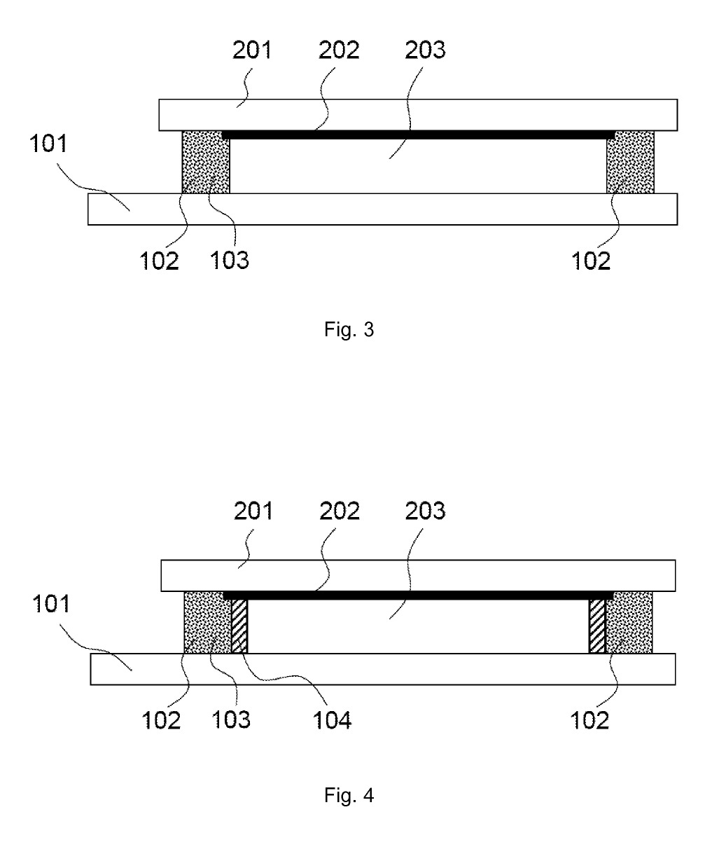

According to another aspect of the invention, an embodiment of the invention provides a liquid crystal display panel. As shown in FIG. 3, the liquid crystal display panel includes: an array substrate 101 and a counter substrate 201 arranged opposite to the array substrate 101; a black matrix 202 arranged on a side of the counter substrate 201 facing the array substrate 101; and a sealant 102 including a matrix material and an insulating material 103 mixed in the matrix material. The sealant 102 is arranged between the array substrate 101 and the counter substrate 201 and arranged at a periphery of the black matrix 202 to form a sealed cavity 203.

By applying the insulating material mixed in the matrix material, the sealant can effectively avoid the electrical connection between the silver paste and the peripheral wiring of the liquid crystal display panel, eliminating the defect of burning the wiring during the electrostatic testing process. Due to the existence of the sealant, it is possible to prevent the silver paste from penetrating into the gap between the array substrate and the counter substrate and contacting the black matrix, thereby avoiding the defect of the greenish edge in the liquid crystal display device.

In certain exemplary embodiments, as shown in FIG. 4, the liquid crystal display panel further includes frame sealing glue 104 arranged at an interior of the sealant 102.

In some embodiments, frame sealing glue is arranged at an interior of the sealant to enhance the bonding between the array substrate and the counter substrate, thereby forming a more stable liquid crystal display panel.

It can be understood by those skilled in the art that for the liquid crystal display panel shown in FIG. 4, if frame sealing glue is arranged at the interior of the sealant, the sealant can be applied to the periphery of the liquid crystal display panel after the cell aligning process. In this case, the frame sealing glue 104 can be a conventional frame sealing glue. The frame sealing glue 104 can be applied to one of the array substrate and the counter substrate with a conventional process. After the cell aligning process, the frame sealing glue 104, the array substrate 101, and the counter substrate 201 form a sealed cavity 203. The sealant 102 can then be applied to the periphery of the frame sealing glue 140 to cover the black matrix 202.

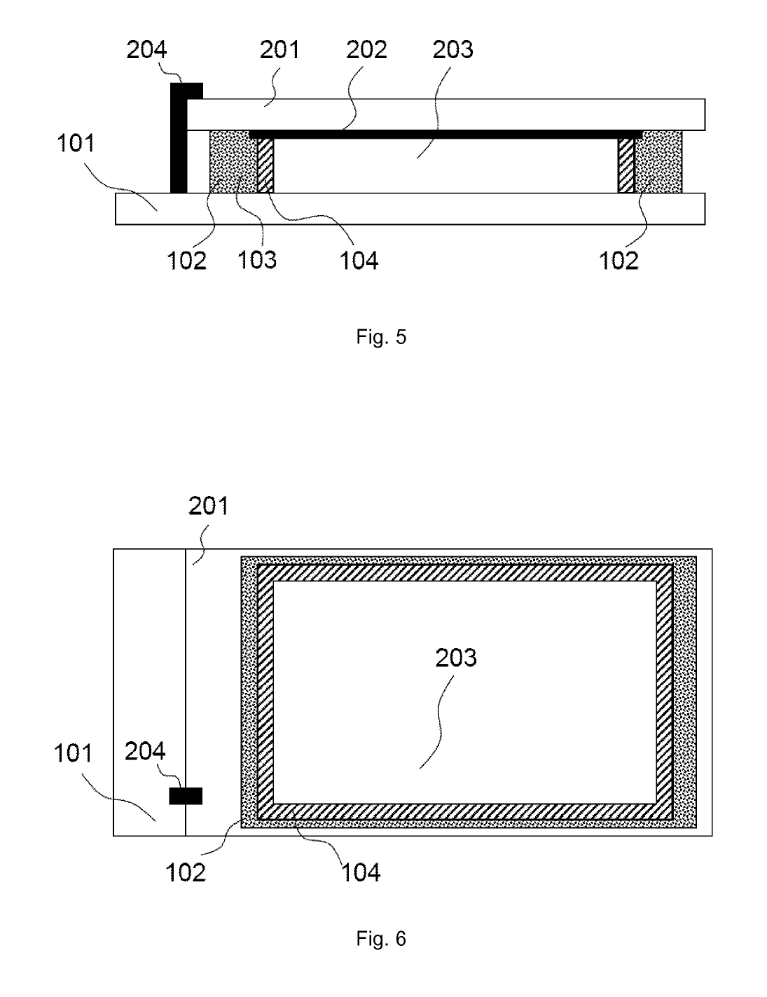

In certain exemplary embodiments, as shown in FIG. 5 and FIG. 6, the liquid crystal display panel further includes a silver paste 204 arranged at a periphery of the sealant 102 and electrically connected with the counter substrate 201. The silver paste 204 can also be connected to a pad on the array substrate, so that the elements on the counter substrate (e.g., an ITO conductive layer) can be connected to ground potential or a preset electrical level, thereby further eliminating the undesired potential difference between the counter substrate and the array substrate.

If the silver paste contacts the black matrix, some charges can be gathered in the black matrix due to the weak conductivity of the black matrix. Then a voltage is on the black matrix, forming a voltage difference with the array substrate, resulting in deflection of liquid crystal and greenish display. By applying the silver paste in this manner, the ability of transmitting static electricity in the liquid crystal display panel can be improved, and the defects of greenish edge in the liquid crystal display device can be further avoided.

In certain exemplary embodiments, the insulating material is a black insulating pigment. The insulating material 103 can be selected from a group of the following materials: black inorganic insulating pigment and black organic insulating pigment. For example, the black insulating pigment can be organic matter such as nigrosine.

With the black pigment, the sealant at the edge of the liquid crystal display panel absorbs all the light emitted to the lateral side of the panel, effectively avoiding the light leakage at the edge of the liquid crystal display panel.

In certain exemplary embodiments, the matrix material is a UV curing material or heat curing material. For example, the matrix material can be a UV curing material, such as acrylic resin and carbamate resin. The matrix material can also be a heat curing material, such as epoxy resin.

By applying the UV curing material or heat curing material, the sealant can be cured simply by means of ultraviolet light or heating.

In certain exemplary embodiments, the counter substrate 201 is a color film substrate.

The liquid crystal display panel can realize color display by using a color film substrate.

According to yet another aspect of the invention, an embodiment of the invention provides a liquid crystal display device. The liquid crystal display device includes the liquid crystal display panel according to any one of the above mentioned embodiments.

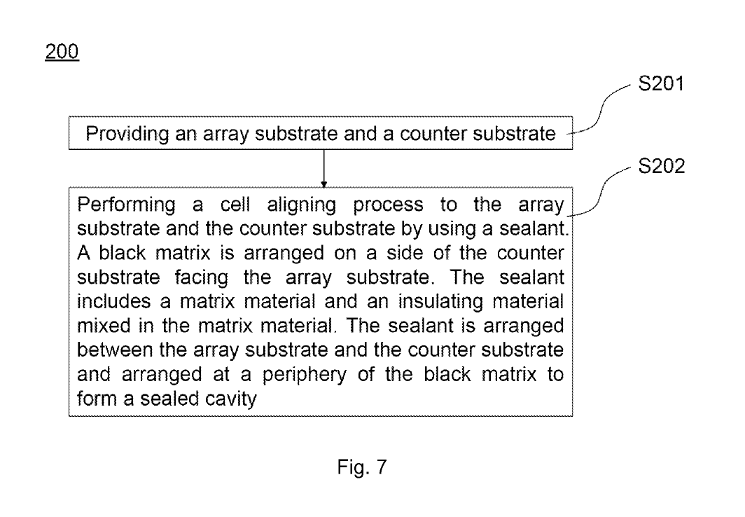

According to still another aspect of the invention, an embodiment of the invention provides a method for manufacturing a liquid crystal display panel. As shown in FIG. 7, the method 200 includes: S201 providing an array substrate and a counter substrate; and S202 performing a cell aligning process to the array substrate and the counter substrate by using a sealant. A black matrix is arranged on a side of the counter substrate facing the array substrate. The sealant includes a matrix material and an insulating material mixed in the matrix material. The sealant is arranged between the array substrate and the counter substrate and arranged at a periphery of the black matrix to form a sealed cavity.

It can be understood by those skilled in the art that for the liquid crystal display panel shown in FIG. 4, if frame sealing glue is arranged at the interior of the sealant, the sealant can be applied to the periphery of the liquid crystal display panel after the cell aligning process. In this case, the frame sealing glue 104 can be a conventional frame sealing glue. The frame sealing glue 104 can be applied to one of the array substrate and the counter substrate with a conventional process. After the cell aligning process, the frame sealing glue 104, the array substrate 101, and the counter substrate 201 form a sealed cavity 203. The sealant 102 can then be applied to the periphery of the frame sealing glue 140 to cover the black matrix 202. In this embodiment, the sealant 102 can be applied to the outside of the frame sealing glue 104 by using a nozzle.

In the sealant, liquid crystal display panel and liquid crystal display device provided by the embodiments of the invention, by applying the insulating material mixed in the matrix material, the sealant can effectively avoid the electrical connection between the silver paste and the peripheral wiring of the liquid crystal display panel, eliminating the defect of burning the wiring during the electrostatic testing process. Due to the existence of the sealant, it is possible to prevent the silver paste from penetrating into the gap between the array substrate and the counter substrate and contacting the black matrix, thereby avoiding the defect of the greenish edge in the liquid crystal display device.

Apparently, the person skilled in the art may make various alterations and variations to the invention without departing the spirit and scope of the invention. As such, provided that these modifications and variations of the invention pertain to the scope of the claims of the invention and their equivalents, the invention is intended to embrace these alterations and variations.

1. A sealant comprising:
a matrix material; and
an insulating material mixed in the matrix material.

2. The sealant according to claim 1, wherein the insulating material is a black insulating pigment.

3. The sealant according to claim 1, wherein the matrix material is a UV curing material or heat curing material.

4. A liquid crystal display panel comprising:
an array substrate and a counter substrate arranged opposite to the array substrate;
a black matrix arranged on a side of the counter substrate facing the array substrate; and
a sealant comprising a matrix material and an insulating material mixed in the matrix material; wherein the sealant is arranged between the array substrate and the counter substrate and arranged at a periphery of the black matrix to form a sealed cavity.

5. The liquid crystal display panel according to claim 4, further comprising frame sealing glue arranged at an interior of the sealant.

6. The liquid crystal display panel according to claim 4, further comprising a silver paste arranged at a periphery of the sealant and electrically connected with the counter substrate.

7. The liquid crystal display panel according to claim 4, wherein the insulating material is a black insulating pigment.

8. The liquid crystal display panel according to claim 4, wherein the matrix material is a UV curing material or heat curing material.

9. The liquid crystal display panel according to claim 4, wherein the counter substrate is a color film substrate.

10. A liquid crystal display device comprising the liquid crystal display panel according to claim 4.

11. The liquid crystal display panel according to claim 5, wherein the insulating material is a black insulating pigment.

12. The liquid crystal display panel according to claim 6, wherein the insulating material is a black insulating pigment.

13. The liquid crystal display panel according to claim 5, wherein the matrix material is a UV curing material or heat curing material.

14. The liquid crystal display panel according to claim 6, wherein the matrix material is a UV curing material or heat curing material.

15. The liquid crystal display panel according to claim 5, wherein the counter substrate is a color film substrate.

16. The liquid crystal display device according to claim 10, further comprising frame sealing glue arranged at an interior of the sealant.

17. The liquid crystal display device according to claim 10, further comprising a silver paste arranged at a periphery of the sealant and electrically connected with the counter substrate.

18. The liquid crystal display device according to claim 10, wherein the insulating material is a black insulating pigment.

19. The liquid crystal display device according to claim 10, wherein the matrix material is a UV curing material or heat curing material.

20. The liquid crystal display device according to claim 10, wherein the counter substrate is a color film substrate.
